(19) United States
(12) Patent Application Publication
(10) Pub. No.: US 2026/0171493 A1
(43) Pub. Date: Jun. 18, 2026

(54) Gel polymer electrolyte self-polymerized at room temperature, method for manufacturing same, and secondary battery containing same

(71) Applicant: POSTECH RESEARCH AND BUSINESS DEVELOPMENT FOUNDATION, Pohang-si (KR)

(72) Inventors: Youn Soo KIM, Pohang-si (KR); SooJin PARK, Pohang-si (KR); SAEHYUN KIM, Pohang-si (KR); Dong-Yeob HAN, Pohang-si (KR); SANGYEOP LEE, Pohang-si (KR)

(21) Appl. No.: 19/417,918

(22) Filed: Dec. 12, 2025

(30) Foreign Application Priority Data
Dec. 13, 2024 (KR) 10-2024-0186279
May 15, 2025 (KR) 10-2025-0063391

(51) Int. Cl. H01M 10/0565; H01M 4/24; H01M 10/36; H01M 50/417; H01M 50/429; H01M 50/437; H01M 50/44

(52) U.S. Cl. CPC H01M 10/0565; H01M 4/244; H01M 10/365; H01M 50/417; H01M 50/4295; H01M 50/437; H01M 50/44; H01M 2300/0082; H01M 2300/0085

(57) ABSTRACT

The present invention relates to a gel polymer electrolyte self-polymerized at room temperature, a method for manufacturing the same, and a secondary battery comprising the same. The gel polymer electrolyte is a gel polymer electrolyte that is self-polymerized and then self-crosslinked without initiators, crosslinkers, and external energy, and is capable of suppressing dendrite formation with high mechanical properties by controlling the concentration of the self-polymerized polymer. When applied as an aqueous zinc battery gel electrolyte, it induces high stability and electrochemical characteristics, and significantly improves the lifespan of the battery by eliminating interfering residues inside the battery system and compounds causing chemical side reactions, thereby improving the capacity characteristics of the battery.

### TECHNICAL FIELD

The present invention provides a gel polymer electrolyte self-polymerized at room temperature, a method for manufacturing the same, and an aqueous zinc secondary battery comprising the same.

### DESCRIPTION OF RELATED ART

Recently, as the growth of population and industry has rapidly developed, the demand for energy storage systems (ESS) is gradually increasing. Aqueous zinc batteries are emerging as promising battery candidates in environments without volume constraints, such as electric vehicle batteries.

The major problems in aqueous zinc batteries are dendrite growth, electrolyte decomposition, gas generation, and anode corrosion, and extensive research is being conducted to solve these problems with gel electrolytes. With recent developments in gel electrolyte research, a technology has been developed wherein a pre-gel solution in which an initiator, crosslinker, monomer, and salt solution are thoroughly mixed is directly wetted to the electrode by an in-situ method, with initiation occurring over time in a closed assembly state, followed by crosslinking to form a gel.

In the case of forming in-situ gel, thermal initiators and redox initiators are mainly used.

In the case of thermal initiators, a process at an elevated temperature of 70° C. or higher is required, and polyethylene separators, which conventionally used as separators have a high heat shrinkage rate, such that when the temperature rises, a short circuit occurs between the positive electrode and the negative electrode, resulting in decreased battery stability.

To address this problem, a gel polymer electrolyte can be formed by curing with a redox initiator in a room temperature process. However, when synthesized in-situ using a redox initiator, problems including a strong redox reaction inside the cell to accelerate corrosion of the zinc anode, creating electrochemical problems inside the battery, or interfering with ion transfer by residual initiators may occur.

Meanwhile, when a crosslinker is used, there is a problem that disordered polymer chains formed by the crosslinker and randomly formed crosslinking points interfere with ion movement within the gel electrolyte.

Therefore, there exists a need for a method for manufacturing aqueous zinc battery gel electrolyte having improved stability while maintaining mechanical strength and ion transfer ability without initiators and crosslinkers.

### DISCLOSURE

### Technical Purposes

It is an object of the present invention to provide a gel polymer electrolyte self-polymerized at room temperature without the use of initiators and crosslinkers.

It is another object of the present invention to provide a method for manufacturing the gel polymer electrolyte.

It is yet another object of the present invention to provide a secondary battery comprising the gel polymer electrolyte.

### Technical Solutions

A method for manufacturing a gel polymer electrolyte according to an embodiment of the present invention comprises a first step of preparing a pre-gel solution by adding a zwitterionic monomer and a metal salt to a solvent and then mixing them; and a second step of applying the pre-gel solution to a separator support, wherein after the second step, the zwitterionic monomer is self-polymerized and crosslinked by cations or anions of the metal salt to form a gel.

In one embodiment, the zwitterionic monomer may include a sulfobetaine methacrylate monomer or an MPC (2-Methacryloyloxyethyl phosphorylcholine) monomer.

In one embodiment, the pre-gel solution may contain the zwitterionic monomer at a concentration of 10 to 20% (w/v).

In one embodiment, the metal salt may include one or more selected from the group consisting of zinc sulfate, zinc trifluoromethanesulfonate, sodium sulfate, and magnesium sulfate. For example, the metal salt may include zinc sulfate or zinc trifluoromethanesulfonate.

In one embodiment, the concentration of the metal salt may be 2 M or more to less than 4 M.

In one embodiment, in the first step, the pre-gel solution may be prepared by adding the zwitterionic monomer and the metal salt to the solvent and then mixing at 20° C. to 25° C. for 10 to 60 seconds.

In one embodiment, ultrasonic waves may be applied to the pre-gel solution for 10 to 60 seconds during the first step.

In one embodiment, 85% or more of the zwitterionic monomer may be converted to gel polymer.

A gel polymer electrolyte according to an embodiment of the present invention may comprise polymer chains of a zwitterionic monomer; and a metal salt having cations and anions that crosslink the polymer chains.

In one embodiment, the zwitterionic monomer may include a sulfobetaine methacrylate monomer or an MPC (2-Methacryloyloxyethyl phosphorylcholine) monomer. For example, the polymer chain of the zwitterionic monomer may include a repeating unit of Formula 1 or Formula 2 below.

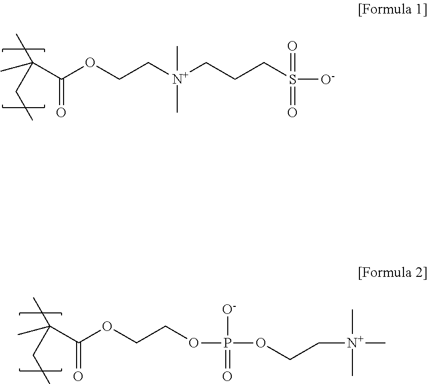

In one embodiment, the polymer chain of the zwitterionic monomer includes the sulfobetaine methacrylate polymer of Formula 1, and the number average molecular weight of the sulfobetaine methacrylate polymer may be 280,000 to 350,000 Da.

In one embodiment, the polydispersity of the sulfobetaine methacrylate polymer may be 1.3 to 1.7.

In one embodiment, the metal salt may include zinc sulfate or zinc trifluoromethanesulfonate.

An aqueous zinc secondary battery according to an embodiment of the present invention comprises a first electrode and a second electrode facing each other; and a gel polymer electrolyte positioned between the first electrode and the second electrode, wherein the gel polymer electrolyte includes polymer chains of a zwitterionic monomer; and a zinc-containing metal salt having cations and anions that crosslink the polymer chains.

In one embodiment, the battery may further include a separator that secures the gel polymer electrolyte between the first electrode and the second electrode, and the separator may include one or more selected from the group consisting of glass fiber, cellulosic filter paper, and hydrophilic polyolefin-based polymer.

In one embodiment, the first electrode may include zinc, and the second electrode may include one or more metals selected from the group consisting of zinc, copper, titanium, stainless steel, and nickel.

In one embodiment, the metal salt includes zinc sulfate or zinc trifluoromethanesulfonate, and the polymer chain of the zwitterionic monomer may include a repeating unit of Formula 1 or Formula 2 below.

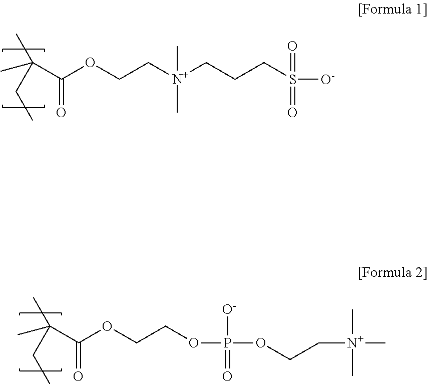

### Technical Effects

The gel polymer electrolyte according to the present invention is a gel polymer electrolyte that is self-polymerized and then self-crosslinked without initiators, crosslinkers, and external energy, and is capable of suppressing dendrite formation with high mechanical properties by controlling the concentration of the self-polymerized polymer. When applied as an aqueous zinc battery gel electrolyte, it induces high stability and electrochemical characteristics, and significantly improves the lifespan of the battery by eliminating interfering residues inside the battery system and compounds causing chemical side reactions, thereby improving the capacity characteristics of the battery.

### BRIEF DESCRIPTION OF THE DRAWINGS

FIG. 1 is an image showing the process of gelation of a self-polymerized polymer in the method for manufacturing a gel polymer electrolyte according to an embodiment of the present invention.

FIG. 2 is an image showing the gelation progress of a self-polymerized polymer manufactured according to an embodiment of the present invention.

FIG. 3 is a 1H NMR graph of a gel polymer electrolyte manufactured according to an embodiment of the present invention and a sulfobetaine methacrylate monomer.

FIG. 4 is a molecular weight (GPC) analysis result of the polymer contained in the gel polymer electrolyte manufactured according to an embodiment of the present invention.

FIG. 5 is a 1H NMR analysis result graph and gelation image of the gel polymer electrolyte manufactured according to an embodiment of the present invention.

FIG. 6 is a 1H NMR analysis result graph of the gel polymer electrolyte according to the concentration of metal salt under conditions of Example 1.

FIG. 7 is an image confirming the gelation progress according to the concentration of metal salt under conditions of Example 1.

FIG. 8 is a graph showing the rheological mechanical properties of the gel polymer electrolyte manufactured according to an embodiment of the present invention.

FIG. 9 shows the results of measuring the cell voltage according to repeated charge/discharge cycles of zinc half cells to which the gel polymer electrolytes prepared in Examples 1 and 2 were applied.

FIG. 10 shows the results of measuring the cell voltage according to repeated charge/discharge cycles of zinc half cells to which the gel polymer electrolytes prepared in Example 1 and Comparative Example 1 were applied.

FIG. 11 shows the results of analyzing the gel polymer electrolyte of Example 3 and a gel polymer obtained by self-polymerizing MPC without using a metal salt through a DSC (Differential Scanning calorimetry) experiment.

FIG. 12 is a 1H NMR analysis result and gelation image of the gel polymer electrolyte of Example 3.

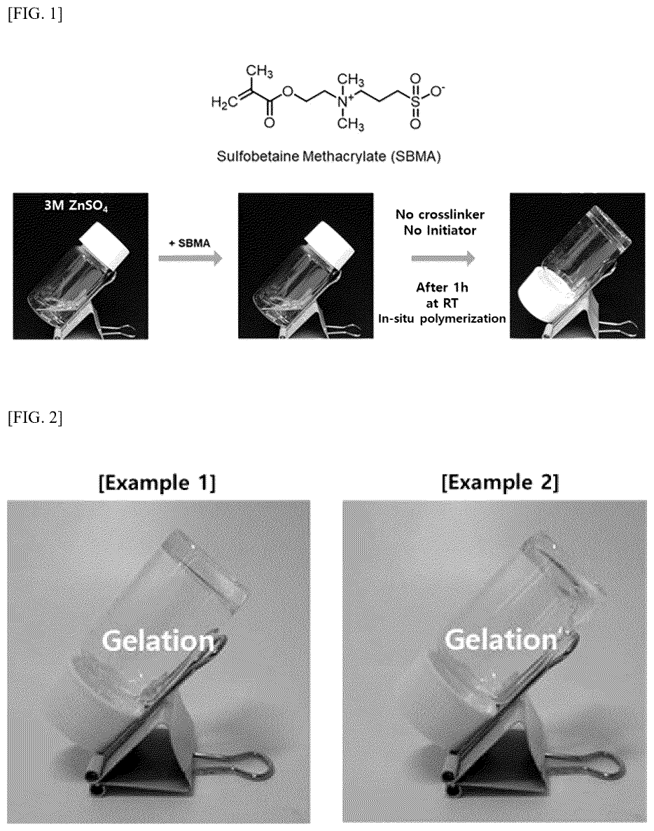

### DETAILED DESCRIPTIONS

Hereinafter, embodiments of the present invention will be described in detail with reference to the accompanying drawings. Since the present invention can have various changes and can have various forms, specific embodiments are illustrated in the drawings and described in detail in the text. However, this is not intended to limit the present invention to a specific disclosed form, and should be understood to include all changes, equivalents, or substitutes included in the spirit and technical scope of the present invention. When describing each drawing, similar reference numerals are used for similar components. In the accompanying drawings, the dimensions of structures are shown enlarged than actual for clarity of the present invention.

Terms such as first, second, etc. may be used to describe various components, but the components should not be limited by the terms. The terms are used only for the purpose of distinguishing one component from another component. For example, a first component may be referred to as a second component without departing from the scope of the present invention, and similarly, a second component may also be referred to as a first component.

Terms used in this application are only used to describe specific embodiments and are not intended to limit the present invention. Singular expressions include plural expressions unless the context clearly indicates otherwise. In this application, terms such as “include” or “have” are intended to designate that features, numbers, steps, operations, components, parts, or combinations thereof described in the specification exist, and should be understood not to preclude in advance the existence or addition possibility of one or more other features, numbers, steps, operations, components, parts, or combinations thereof.

Meanwhile, unless defined otherwise, all terms used herein, including technical or scientific terms, have the same meaning as commonly understood by one of ordinary skill in the art to which this invention belongs. Terms such as those defined in commonly used dictionaries should be interpreted as having a meaning consistent with the meaning in the context of the related art, and unless explicitly defined in this application, are not interpreted in an ideal or excessively formal sense.

A method for manufacturing a gel polymer electrolyte according to the present invention comprises a first step of preparing a pre-gel solution by adding a zwitterionic monomer and a metal salt to a solvent and then mixing them; and a second step of applying the pre-gel solution to a separator support, wherein after the second step, the sulfobetaine methacrylate monomers are self-polymerized and crosslinked by cations or anions of the metal salt to form a gel.

In the first step, the zwitterionic monomer may include a sulfobetaine methacrylate monomer or an MPC (2-Methacryloyloxyethyl phosphorylcholine) monomer. In one embodiment, in the pre-gel solution, the concentration of the sulfobetaine methacrylate monomer may be about 10 to 20% (w/v) or about 13 to 17% (w/v). By mixing the monomer at such a concentration, the ratio of monomer conversion to polymer can be improved.

In one embodiment, the metal salt may include one or more selected from zinc sulfate, zinc trifluoromethanesulfonate salt, sodium sulfate, and magnesium sulfate.

A concentration of the metal salt may be about 2 M or more and less than about 4 M. For example, the concentration of the metal salt may be about 2.5 to 3.5 M or 3.0 to 4.0 M. By mixing the metal salt at such a concentration, the sulfobetaine methacrylate polymers are crosslinked by cations or anions of the metal salt to effectively form a gel, and the zwitterionic monomers is polymerizable at room temperature.

In one embodiment, the pre-gel solution may be prepared by adding the zwitterionic monomer and metal salt to the solvent and then mixing at about 20° C. to 25° C. for about 10 to 60 seconds or about 10 to 30 seconds.

In one embodiment, ultrasonic waves may be applied to the pre-gel solution for about 10 to 60 seconds or about 10 to 30 seconds. By applying ultrasonic waves as described above, the monomer can be effectively dissolved in the solvent.

In the second step, the separator support may include one or more selected from the group consisting of glass fiber, cellulosic filter paper, and hydrophilic polyolefin-based polymer.

In one embodiment, the pre-gel solution may be applied to the separator support through methods such as immersion, spin coating, blade casting, drop casting, or dip coating.

The method for manufacturing a gel polymer electrolyte according to the present invention forms a self-polymerized polymer chain at room temperature in a short time by mixing the zwitterionic monomer and the metal salt at an appropriate concentration. Meanwhile, the polymer of the zwitterionic monomer and ions derived from the metal salt may be mixed in the gel polymer electrolyte.

A gel polymer electrolyte according to an embodiment of the present invention may include polymer chains of a zwitterionic monomer; and a metal salt having cations and anions that crosslink the polymer chains.

In one embodiment, the gel polymer electrolyte may be manufactured by the method for manufacturing a gel polymer electrolyte according to an embodiment of the present invention described above, or may be manufactured by other methods.

In one embodiment, the zwitterionic monomer may include a sulfobetaine methacrylate monomer or an MPC (2-Methacryloyloxyethyl phosphorylcholine) monomer. For example, the polymer chain of the zwitterionic monomer may include a repeating unit of Formula 1 or Formula 2 below.

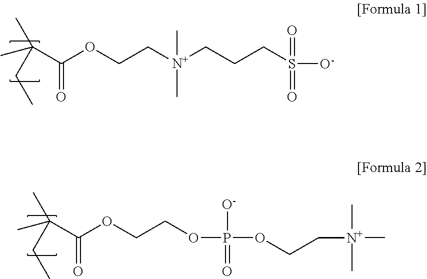

In one embodiment, the number average molecular weight of the sulfobetaine methacrylate polymer of Formula 1 may be about 280,000 to 350,000 Da or about 300,000 to 330,000 Da, and the polydispersity of the sulfobetaine methacrylate polymer may be about 1.3 to 1.7.

In one embodiment, the metal salt may include one or more selected from the group consisting of zinc sulfate, zinc trifluoromethanesulfonate, sodium sulfate, and magnesium sulfate.

Since the gel polymer electrolyte according to an embodiment of the present invention is prepared by mixing the zwitterionic monomer and the metal salt at an appropriate concentration, it may include a polymer of the zwitterionic monomer having the number average molecular weight and polydispersity as described above.

An aqueous zinc secondary battery according to an embodiment of the present invention may include a first electrode and a second electrode facing each other; and a gel polymer electrolyte positioned between the first electrode and the second electrode.

In one embodiment, the first electrode may include zinc, and the second electrode may include one or more metals selected from the group consisting of zinc, copper, titanium, stainless steel, and nickel.

In one embodiment, the second electrode may further include an active material on the surface facing the first electrode, and the active material may include one or more selected from the group consisting of manganese dioxide, vanadium pentoxide, and Prussian blue.

In one embodiment, since the gel polymer electrolyte according to an embodiment of the present invention described above is used as the gel polymer electrolyte, duplicate detailed description thereof is omitted.

In one embodiment, the aqueous zinc secondary battery may further include a separator that secures the gel polymer electrolyte between the first electrode and the second electrode. In one embodiment, the separator may include one or more selected from the group consisting of glass fiber, cellulosic filter paper, and hydrophilic polyolefin-based polymer.

Hereinafter, the present invention will be described in detail through examples and the like to help understanding of the present invention. However, the following examples and the like are only intended to illustrate the contents of the present invention, and the scope of the present invention is not limited to the following examples and the like. The examples and the like of the present invention are provided to more completely explain the present invention to those of ordinary skill in the art.

### [Example 1] Preparation of Gel Polymer Electrolyte

15% (w/v) sulfobetaine methacrylate was added into 2 ml of 3 M zinc sulfate aqueous solution, and then vortexing and ultrasonication were conducted thereby preparing a pre-gel solution.

Subsequently, the pre-gel solution was maintained at room temperature for 24 hours to effect gelation thereby preparing a gel polymer electrolyte.

### Example 2

A gel polymer electrolyte was prepared in the same manner as in Example 1, except that 10% (w/v) sulfobetaine methacrylate was added into 2 ml of 3 M zinc sulfate aqueous solution.

### Example 3

A gel polymer electrolyte was prepared in the same manner as in Example 1, except that 15% (w/v) MPC (2-Methacryloyloxyethyl phosphorylcholine) was added into 2 ml of 3 M zinc sulfate aqueous solution.

### Comparative Example 1

N,N′-methylenebisacrylamide (MBAA) as a crosslinker, APS (Ammonium Persulfate) as an initiator, and TEMED (Tetramethylethylenediamine) as an accelerator were added together with sulfobetaine methacrylate to 2 ml of 3 M zinc sulfate aqueous solution, and then vortexing and ultrasonication were conducted thereby preparing a pre-gel solution. At this time, the molar ratio of sulfobetaine methacrylate to crosslinker was added at 1000:1, and the molar ratios of sulfobetaine methacrylate to initiator and sulfobetaine methacrylate to accelerator were both added at 1000:5.

Subsequently, gelation was conducted in the same manner as in Example 1 by maintaining the pre-gel solution at room temperature for 24 hours thereby preparing a gel polymer electrolyte.

### Comparative Example 2

A gel polymer electrolyte was prepared in the same manner as in Example 1, except that 5% (w/v) sulfobetaine methacrylate was added into 2 ml of 3 M zinc sulfate aqueous solution.

### Experimental Example 1

In order to confirm the self-polymerized polymer in the method for manufacturing a gel polymer electrolyte according to an embodiment of the present invention, gelation image photography was obtained and ¹H NMR analysis was conducted, and the results are shown in FIGS. 2 to 5.

¹H NMR analysis was performed through nuclear magnetic resonance spectroscopy (NMR) experiment, and at this time, the NMR experiment was performed using Bruker AVANCE III 500 MHz NMR. For 1H NMR analysis, the prepared pre-gel solution was self-polymerized at room temperature without external energy for 24 hours to form a gel, freeze-drying was performed on the gel for 24 to 36 hours thereby preparing a solidified gel, and a sample was prepared by dissolving the solidified gel after freeze-drying in deuterium oxide (D2O) solvent.

FIG. 2 is an image comparing the gelation state of the self-polymerized gel polymer electrolytes prepared in Examples 1 and 2.

As shown in FIG. 2, in the case of the gel polymer electrolyte of Example 1, the polymer conversion rate was high and gelation proceeded successfully, and as a result, it is confirmed that the gel electrolyte is maintained in a stable manner without displacement while being fixed to the bottom of the vial while maintaining its shape. On the other hand, in the case of the gel polymer electrolyte of Example 2, the polymer conversion rate was comparatively reduced and gelation was insufficiently achieved, and it is confirmed that the gel polymer electrolyte partially displaced when the vial was tilted.

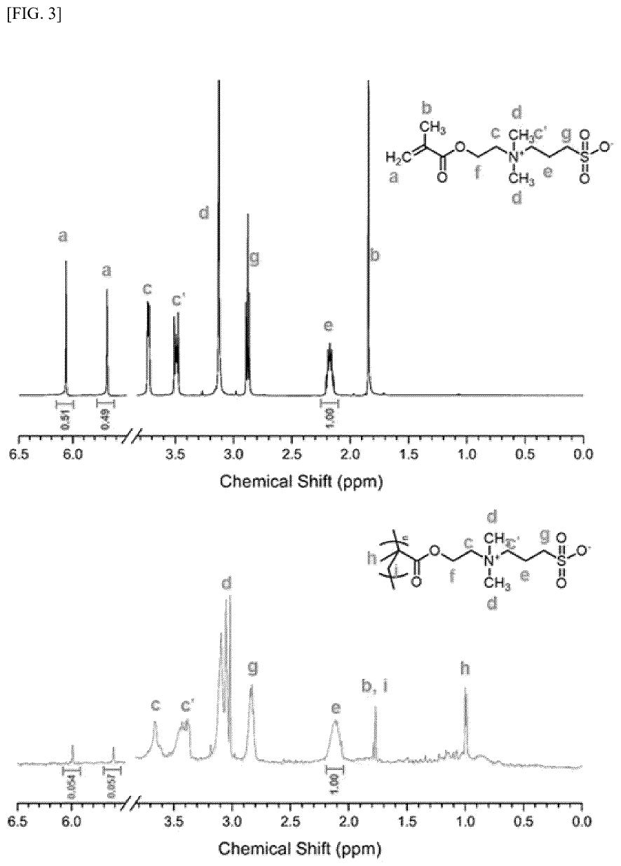

FIG. 3 is a 1H NMR analysis result of the gel polymer electrolyte of Example 1 and the sulfobetaine methacrylate monomer.

As shown in FIG. 3, it is confirmed that sulfobetaine methacrylate self-polymerized successfully at room temperature through the ¹H NMR graph of the gel polymer electrolyte of Example 1. Through the height and area of the vinyl group double bond a contained in the sulfobetaine methacrylate monomer, the monomer-to-polymer conversion ratio can be calculated, and through this, the degree of monomer polymerization is confirmed.

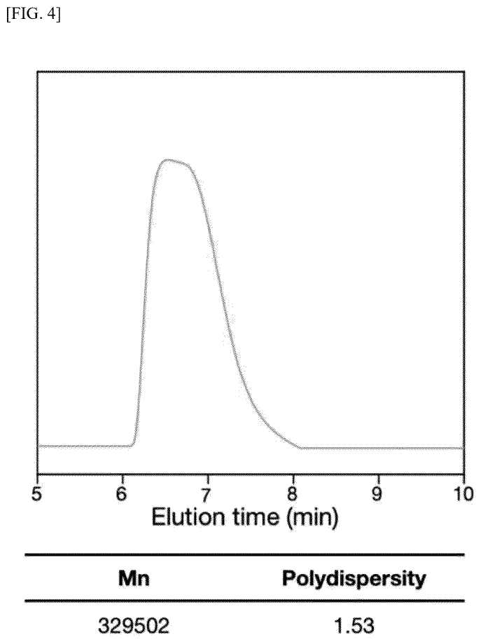

FIG. 4 is a molecular weight (GPC) analysis result of the polymer contained in the gel polymer electrolyte of Example 1. In the GPC analysis, the solvent consisted of Water Anionic (0.15 M NaNO₃) and 10% MEOH, and the molecular weight was measured by completely dissolving the gel polymer of Example 1 in the solvent.

As shown in FIG. 4, the molecular weight of the self-polymerized polymer in the gel polymer electrolyte of Example 1 was confirmed to be 329,502 Da, and the polydispersity was confirmed to be 1.53.

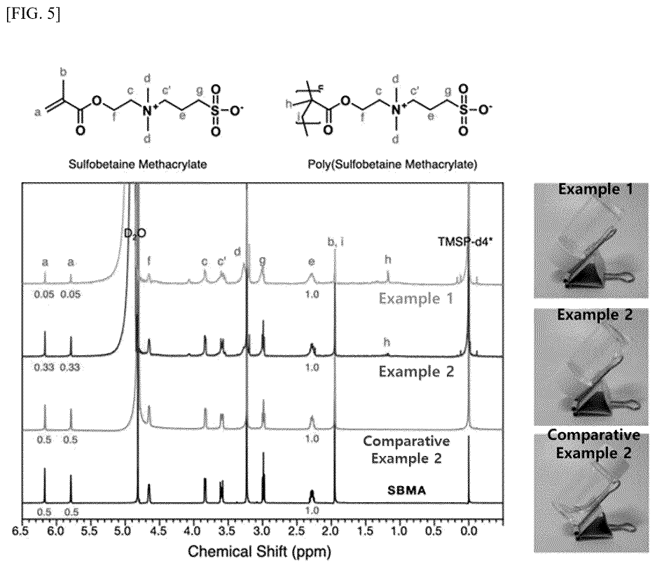

FIG. 5 is a 1H NMR analysis result and gelation image of the gel polymer electrolytes of Examples 1, 2, and Comparative Example 2.

As shown in FIG. 5, in the case of the gel polymer electrolyte of Example 1, the polymer conversion rate was 90%, in the case of the gel polymer electrolyte of Example 2, the polymer conversion rate was 44%, and in the case of Comparative Example 2 (S5Z), it was found that the monomer was not converted to polymer. Based on this, it requires inclusion of the zwitterionic monomer in a concentration above a certain level, for example, in excess of at least 5% (w/v) to form a gel polymer.

### Experimental Example 2

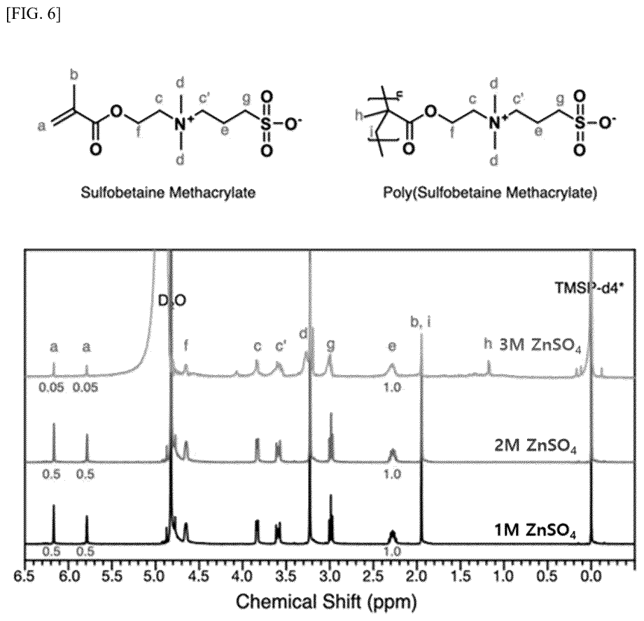

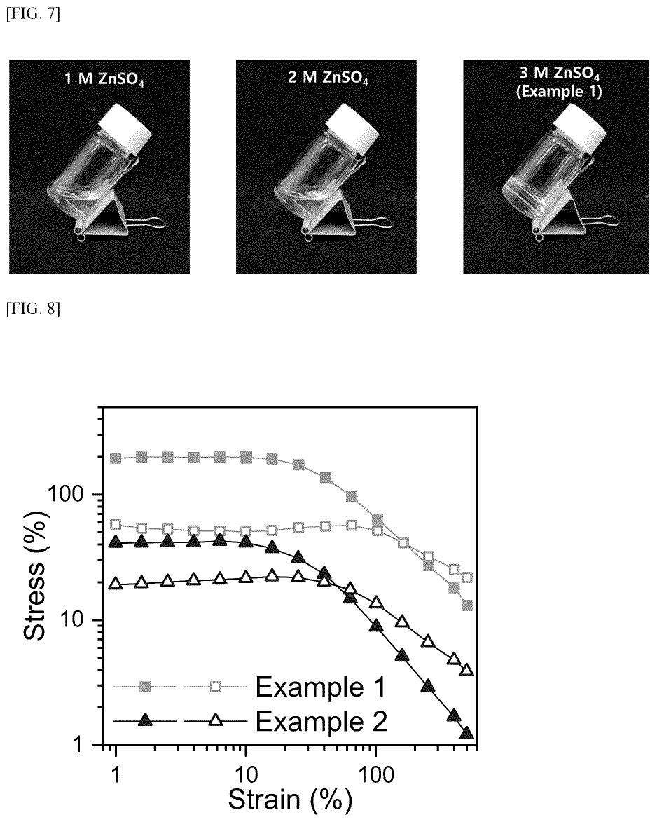

In order to confirm the gelation progress of the gel polymer electrolyte according to the concentration of metal salt in the method for manufacturing a gel polymer electrolyte according to the present invention, ¹H NMR analysis and photography were conducted on gel polymer electrolytes prepared by changing the concentration of metal salt under the conditions of Example 1, and the results are shown in FIGS. 6 and 7.

FIG. 6 is a 1H NMR analysis result of the gel polymer electrolyte prepared by changing the concentration of metal salt under the conditions of Example 1, and FIG. 7 is an image of the gel polymer electrolyte formed by changing the concentration of metal salt under the conditions of Example 1.

Referring to FIGS. 6 and 7, for 15% (w/v) sulfobetaine methacrylate, only when 3M zinc sulfate was mixed, gelation proceeded and the polymer conversion rate was 90%, and when 1M and 2M zinc sulfate were mixed, minimal gelation occurred.

### Experimental Example 3

In order to confirm the gel mechanical properties and electrochemical characteristics of the gel polymer electrolyte according to the present invention, rheological mechanical characteristics and charge/discharge experiments of zinc half cells were conducted on the gel polymer electrolytes of Examples 1 and 2, and the results are shown in FIGS. 8 to 10.

In the method for analyzing the mechanical properties of the gel polymer electrolyte, the rheological properties of the polymer were measured using a rheometer, and more specifically, the shear storage modulus (G′), shear loss modulus (G″), and shear complex viscosity (η*) were measured. The mechanical characteristics of the room temperature self-polymerized gel were measured with a rheometer (T-1040, TA instrument) with parallel plates of 20 mm diameter.

A gel polymer electrolyte was prepared according to Example 1 in a flask blocked from external air, and an oscillation strain test was conducted from 1% to 500% at a frequency of 1 rad/s.

Zinc half cell preparation and evaluation were conducted by preparing a symmetric cell in coin cell form. The symmetric cell employed a zinc metal disk as a working electrode, counter electrode, and reference electrode, and the polymer gel electrolyte was applied by wetting the pre-gel solutions of Examples 1 and 2 on a glass fiber-based separator and self-polymerizing at room temperature for 24 hours.

FIG. 8 is a graph showing the rheological mechanical properties of the gel polymer electrolytes prepared in Examples 1 and 2.

As shown in FIG. 8, the gel polymer electrolyte of Example 1 showed an elevated stress value overall compared to the applied strain than the gel polymer electrolyte of Example 2, and in particular, it is confirmed that stress was maintained without structural collapse even in the high strain region (>100%). This means that the gel polymer electrolyte of Example 1 has a higher polymer conversion rate than the gel polymer electrolyte of Example 2 and has excellent resistance to external stress. In addition, the gel polymer electrolyte of Example 1 showed an elevated storage modulus within the experimental range, which means that the gel polymer electrolyte of Example 1 has enhanced elastic characteristics and can store energy with enhanced effectiveness against external deformation.

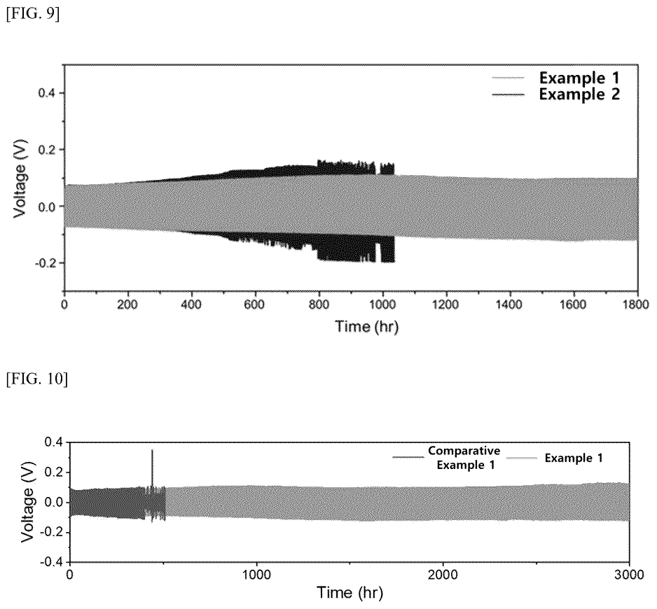

FIG. 9 shows the results of measuring the cell voltage according to repeated charge/discharge cycles of zinc half cells to which the gel polymer electrolytes prepared in Examples 1 and 2 were applied.

As shown in FIG. 9, the gel polymer electrolyte prepared in Example 1 showed superior long-life characteristics than the gel polymer electrolyte prepared in Example 2. This means that there is an optimal concentration when making the gel polymer electrolyte, and this concentration also affects the electrochemical characteristics based on the rheological mechanical properties of the gel.

FIG. 10 shows the results of measuring the cell voltage according to repeated charge/discharge cycles of zinc half cells to which the gel polymer electrolytes prepared in Example 1 and Comparative Example 1 were applied.

As shown in FIG. 10, while the symmetric cell to which the gel polymer electrolyte of Comparative Example 1 was applied had an internal short circuit immediately after 400 hours, the symmetric cell to which the gel polymer electrolyte of Example 1 was applied showed long-life characteristics of 1,800 hours or more. From this, it is confirmed that the gel polymer electrolyte self-polymerized without initiators and accelerators is excellent not only in mechanical properties but also in electrochemical characteristics.

### Experimental Example 4

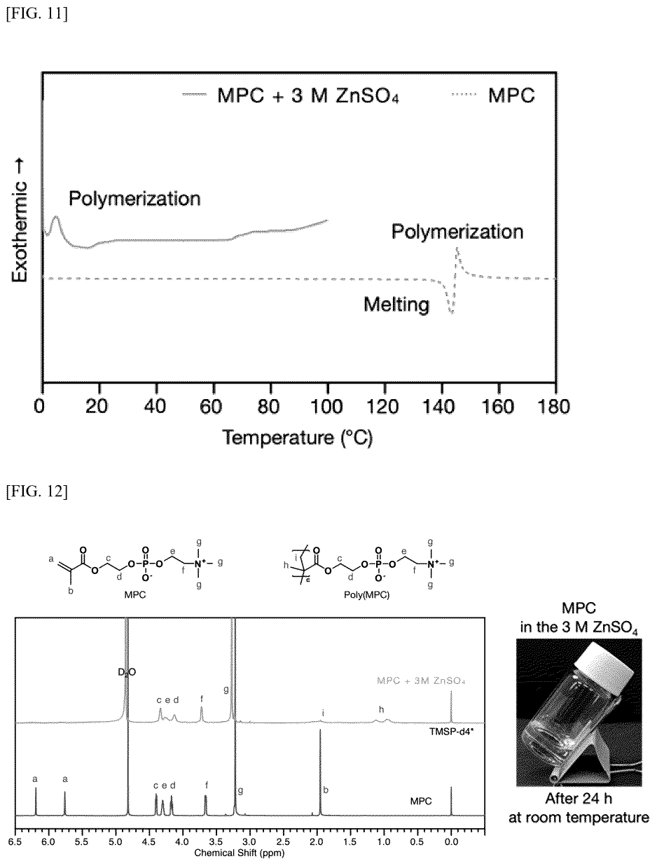

FIG. 11 shows the results of analyzing the gel polymer electrolyte of Example 3 and a gel polymer obtained by self-polymerizing MPC without using a metal salt through a DSC (Differential Scanning calorimetry) experiment.

As shown in FIG. 11, the gel polymer obtained by self-polymerizing MPC without using a metal salt showed an exothermic peak around 150° C., whereas the gel polymer electrolyte of Example 3 showed an exothermic peak at 10-15° C. From this, it is evident that when MPC is self-polymerized alone, thermal energy of about 150° C. is required, but when MPC is polymerized under conditions with cations and anions derived from zinc sulfate according to Example 3, polymerization and gelation proceed with only thermal energy of about 10-15° C.

FIG. 12 is a 1H NMR analysis result and gelation image of the gel polymer electrolyte of Example 3.

As shown in FIG. 12, it is confirmed that when the pre-gel containing zinc sulfate and MPC monomer is maintained at room temperature for 24 hours according to Example 3, formation of polymers of MPC monomers and crosslinking between polymers occur to achieve gelation.

The above description of the present invention is for illustration, and those of ordinary skill in the art to which the present invention belongs will be able to understand that it can be easily modified into other specific forms without changing the technical spirit or essential features of the present invention. Therefore, it should be understood that the embodiments described above are illustrative in all respects and not restrictive.

The scope of the present invention is indicated by the claims described below, and all changes or modified forms derived from the meaning and scope of the claims and their equivalent concepts should be interpreted as being included in the scope of the present invention.

What is claimed is:

1. A method for manufacturing a gel polymer electrolyte comprising:
a first step of preparing a pre-gel solution by adding a zwitterionic monomer and a metal salt to a solvent and then mixing them; and
a second step of applying the pre-gel solution to a separator support,
wherein after the second step, the zwitterionic monomer is self-polymerized and crosslinked by cations or anions of the metal salt to form a gel.

2. The method of claim 1, wherein the zwitterionic monomer includes a sulfobetaine methacrylate monomer or an MPC (2-Methacryloyloxyethyl phosphorylcholine) monomer.

3. The method of claim 2, wherein the pre-gel solution contains the zwitterionic monomer at a concentration of 10 to 20% (w/v).

4. The method of claim 1, wherein the metal salt includes one or more selected from the group consisting of zinc sulfate, zinc trifluoromethanesulfonate, sodium sulfate, and magnesium sulfate.

5. The method of claim 4, wherein the metal salt includes zinc sulfate or zinc trifluoromethanesulfonate.

6. The method of claim 4, wherein the concentration of the metal salt is 2 M or more to less than 4 M.

7. The method of claim 1, wherein in the first step, the pre-gel solution is prepared by adding the zwitterionic monomer and the metal salt to the solvent and then mixing at 20° C. to 25° C. for 10 to 60 seconds.

8. The method of claim 7, wherein ultrasonic waves are applied to the pre-gel solution for 10 to 60 seconds during the first step.

9. The method of claim 1, wherein 85% or more of the zwitterionic monomer is converted to gel polymer.

10. A gel polymer electrolyte comprising:
polymer chains of a zwitterionic monomer; and
a metal salt having cations or anions that crosslink the polymer chains.

11. The gel polymer electrolyte of claim 10, wherein the zwitterionic monomer includes a sulfobetaine methacrylate monomer or an MPC (2-Methacryloyloxyethyl phosphorylcholine) monomer.

12. The gel polymer electrolyte of claim 11, wherein the polymer chain of the zwitterionic monomer includes a repeating unit of Formula 1 or Formula 2 below:

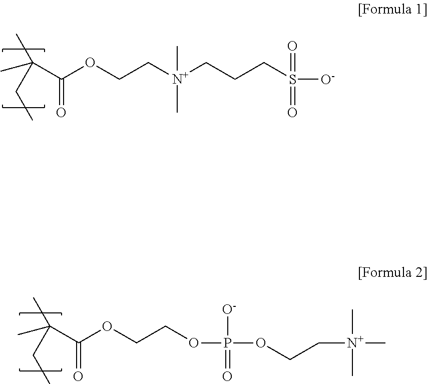

13. The gel polymer electrolyte of claim 12, wherein the polymer chain of the zwitterionic monomer includes the sulfobetaine methacrylate polymer of Formula 1, and the number average molecular weight of the sulfobetaine methacrylate polymer is 280,000 to 350,000 Da.

14. The gel polymer electrolyte of claim 13, wherein the polydispersity of the sulfobetaine methacrylate polymer is 1.3 to 1.7.

15. The gel polymer electrolyte of claim 8, wherein the metal salt includes zinc sulfate or zinc trifluoromethanesulfonate.

16. An aqueous zinc secondary battery comprising:
a first electrode and a second electrode facing each other; and
a gel polymer electrolyte positioned between the first electrode and the second electrode,
wherein the gel polymer electrolyte includes: polymer chains of a zwitterionic monomer; and a zinc-containing metal salt having cations or anions that crosslink the polymer chains.

17. The aqueous zinc secondary battery of claim 16, further comprising a separator that secures the gel polymer electrolyte between the first electrode and the second electrode,
wherein the separator includes one or more selected from the group consisting of glass fiber, cellulosic filter paper, and hydrophilic polyolefin-based polymer.

18. The aqueous zinc secondary battery of claim 16, wherein the first electrode includes zinc, and the second electrode includes one or more metals selected from the group consisting of zinc, copper, titanium, stainless steel, and nickel.

19. The aqueous zinc secondary battery of claim 16, wherein the metal salt includes zinc sulfate or zinc trifluoromethanesulfonate, and the polymer chain of the zwitterionic monomer includes a repeating unit of Formula 1 or Formula 2 below: [chemical structure]
